(19) United States
(12) Patent Application Publication
(10) Pub. No.: US 2026/0001384 A1
(43) Pub. Date: Jan. 1, 2026

(54) VEHICLE AIR CONDITIONING SYSTEM

(71) Applicant: SUBARU CORPORATION, Tokyo (JP)

(72) Inventor: Yuki OHARA, Tokyo (JP)

(21) Appl. No.: 19/228,875

(22) Filed: Jun. 5, 2025

(30) Foreign Application Priority Data
Jun. 26, 2024 (JP) 2024-102847

(51) Int. Cl. B60H 1/00

(52) U.S. Cl. CPC B60H 1/00835; B60H 1/00785; B60H 2001/00085

(57) ABSTRACT

A vehicle air conditioning system includes an inside/outside air switching door configured to adjust an outside air intake amount from an outside air introduction port and an inside air intake amount from an inside air introduction port; a first inside air intake amount calculator configured to calculate a first inside air intake amount for achieving high air conditioning efficiency, based on an air conditioning load; a second inside air intake amount calculator configured to calculate a second inside air intake amount for limiting ingress of moisture from the outside air introduction port, based on a vehicle body angle and a weather condition; and an inside air intake amount setter configured to set the inside air intake amount using the inside/outside air switching door, based on a larger one of the first inside air intake amount and the second inside air intake amount.

### CROSS-REFERENCE TO RELATED APPLICATIONS

The present application claims priority from Japanese Patent Application No. 2024-102847 filed on Jun. 26, 2024, the entire contents of which are hereby incorporated by reference.

### BACKGROUND

The disclosure relates to a vehicle air conditioning system for air-conditioning the interior of a vehicle.

A vehicle air conditioning system for air-conditioning the interior of a vehicle such as an automobile includes an air conditioner, and the air conditioner includes an air-conditioning duct having in an upstream portion thereof an outside air introduction port for introducing air outside the vehicle and an inside air introduction port for introducing air in the interior of the vehicle. Opening degrees of the outside air introduction port and the inside air introduction port are adjusted by an inside/outside air switching door. The adjustment of the opening degrees by the inside/outside air switching door is controlled by an air conditioning control unit.

The air conditioner having the configuration described above is provided with a cowl top cover above the outside air introduction port. An outside air introduction passage is formed below the cowl top cover to communicate with the outside air introduction port. The cowl top cover has holes for introducing the outside air into the outside air introduction passage.

When the vehicle is traveling in rainy weather, rainwater may enter the outside air introduction passage together with the outside air through the holes in the cowl top cover. Various techniques for limiting the ingress of rainwater that has entered the outside air introduction passage into the outside air introduction port have been proposed in the related art.

For example, Japanese Unexamined Patent Application Publication (JP-A) No. 2020-185888 discloses a vehicle air conditioner that switches a portion of an amount of introduced outside air (outside air intake amount) into inside air when an air volume specified for rainy weather becomes greater than or equal to a predetermined air volume and an outside air introduction mode is requested.

### SUMMARY

An aspect of the disclosure provides a vehicle air conditioning system including an inside/outside air switching door, a first inside air intake amount calculator, a second inside air intake amount calculator, and an inside air intake amount setter. The inside/outside air switching door is configured to adjust an outside air intake amount from an outside air introduction port and an inside air intake amount from an inside air introduction port. The first inside air intake amount calculator is configured to calculate a first inside air intake amount for achieving high air conditioning efficiency, based on an air conditioning load. The second inside air intake amount calculator is configured to calculate a second inside air intake amount for limiting ingress of moisture from the outside air introduction port, based on a vehicle body angle and a weather condition. The inside air intake amount setter is configured to set the inside air intake amount using the inside/outside air switching door, based on a larger one of the first inside air intake amount and the second inside air intake amount.

An aspect of the disclosure provides a vehicle air conditioning system including an inside/outside air switching door and a controller. The inside/outside air switching door is configured to adjust an outside air intake amount from an outside air introduction port and an inside air intake amount from an inside air introduction port. The controller includes circuitry and is configured to control the inside/outside air switching door. The controller is configured to calculate a first inside air intake amount for achieving high air conditioning efficiency, based on an air conditioning load. The controller is configured to calculate a second inside air intake amount for limiting ingress of moisture from the outside air introduction port, based on a vehicle body angle and a weather condition. The controller is configured to set the inside air intake amount using the inside/outside air switching door, based on a larger one of the first inside air intake amount and the second inside air intake amount.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a perspective view of a front portion of a vehicle body from which an engine hood is removed;

FIG. 2 is a schematic configuration diagram of a vehicle air conditioning system;

FIG. 3 illustrates a map for calculating a reference inside air intake amount based on air volume;

FIG. 4 illustrates a map for calculating a correction amount based on a vehicle body longitudinal angle;

FIG. 5 illustrates a map for calculating a correction amount based on a vehicle body lateral angle;

FIG. 6 illustrates a map for calculating a correction amount based on an amount of rainfall;

FIG. 7 is a flowchart illustrating an inside air intake amount control routine;

FIG. 8 is a flowchart illustrating the inside air intake amount control routine, continued from FIG. 7;

FIG. 9 is a flowchart illustrating a dehumidification capacity margin determination subroutine;

FIG. 10 illustrates a map for calculating an inside air introduction port opening degree based on inside air intake amount; and

FIG. 11 is a flowchart illustrating a portion of an inside air intake amount control routine according to a modification.

### DETAILED DESCRIPTION

The technique disclosed in JP-A No. 2020-185888 is basically a technique for limiting the ingress of rainwater by restricting the outside air intake amount in the outside air introduction mode. Thus, for example, depending on the inclination of the vehicle body when the vehicle is traveling, it is difficult to fully limit the ingress of rainwater. Further, if, as in the technique disclosed in JP-A No. 2020-185888, the amounts of inside air and outside air introduced are uniformly changed when the air volume in rainy weather becomes greater than or equal to a predetermined value, air conditioning control may be performed inefficiently.

Accordingly, it is desirable to provide a vehicle air conditioning system that can limit the ingress of rainwater into an outside air introduction port even when a weather condition changes and an inclination of a vehicle body changes, while achieving high air conditioning efficiency.

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

A configuration of a front portion of a vehicle body of a vehicle on which a vehicle air conditioning system according to the present embodiment is mounted will be described. The vehicle according to the present embodiment is a right-hand drive vehicle in which the driver's seat is on the right side.

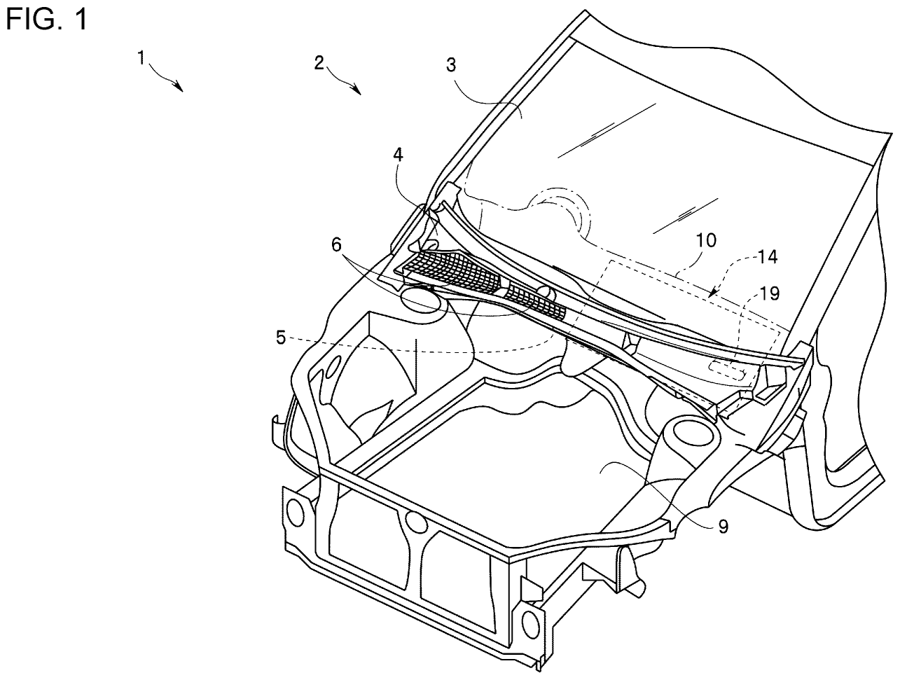

As illustrated in FIG. 1, a front portion of a vehicle body 2 of a vehicle 1 includes a front windshield glass 3 (hereinafter referred to as a windshield 3), a cowl top cover 4, and a dashboard upper panel 5.

The windshield 3 is provided in a front portion of front seats of the vehicle 1.

The cowl top cover 4 is located in a lower end portion of the windshield 3 on the vehicle outer side and extends in a vehicle width direction. The cowl top cover 4 has openings 6.

The openings 6 are formed in, for example, a portion of the cowl top cover 4 near the driver's seat in the vehicle width direction. The openings 6 serve as outside air introduction ports for introducing outside air.

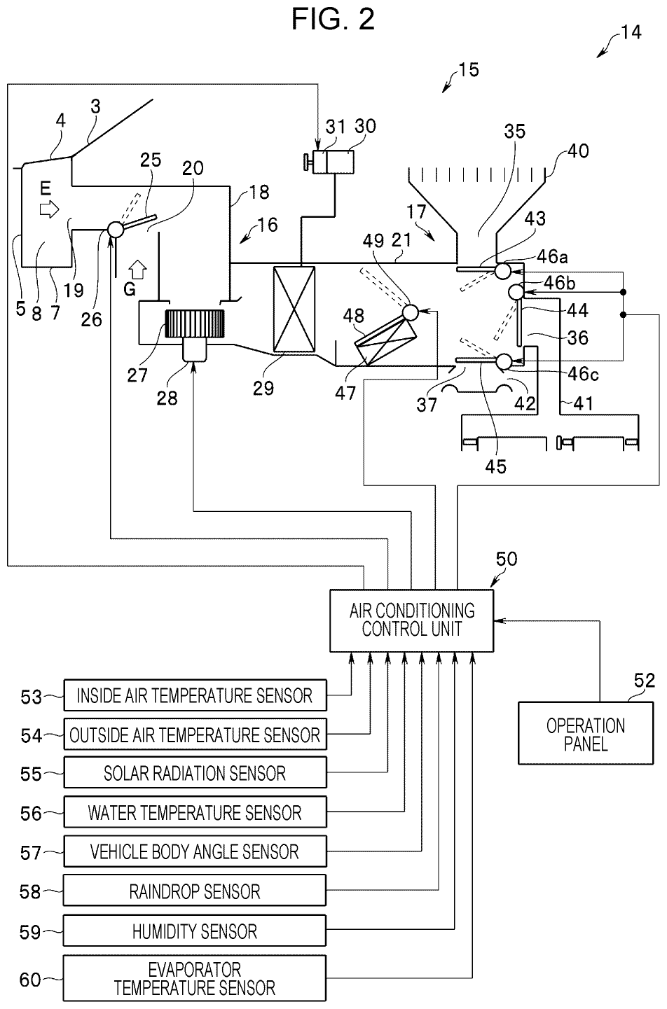

The dashboard upper panel 5 is disposed, in an engine room 9, below the cowl top cover 4, as illustrated in FIG. 2. The dashboard upper panel 5 has a downward concave shape. Due to the concave shape, a bottom portion 7 of the dashboard upper panel 5 is disposed at a position away from the cowl top cover 4. The dashboard upper panel 5 having the configuration described above extends in the vehicle width direction. Accordingly, an outside air introduction passage 8 is formed between the cowl top cover 4 and the dashboard upper panel 5.

The outside air introduction passage 8 can lead the outside air introduced from the openings 6 (see FIG. 1) into the outside air introduction passage 8 to an outside air introduction port 19 of a vehicle air conditioner 15 (hereinafter referred to as an air conditioner 15) described below. Further, the outside air introduction passage 8 can guide, for example, rainwater dropping from the openings 6 in rainy weather in the vehicle width direction along the bottom portion 7 through the outside air introduction passage 8. The outside air introduction passage 8 can also lead rainwater guided along the bottom portion 7 into a drain hole (not illustrated) provided on the outer side in the vehicle width direction. As a result, rainwater entering the outside air introduction passage 8 is discharged to the outside through the drain hole.

In an interior front portion of the vehicle body 2, a vehicle air conditioning system 14 (hereinafter referred to as an air conditioning system 14) is provided inside an instrument panel 10.

As illustrated in FIG. 2, the air conditioning system 14 includes the air conditioner 15 and an air conditioning control unit 50.

The air conditioner 15 includes a blower cooling unit 16 and a heater unit 17.

The blower cooling unit 16 includes a first air-conditioning duct 18. The outside air introduction port 19 and an inside air introduction port 20 are provided in an upstream portion of the first air-conditioning duct 18.

The outside air introduction port 19 communicates with the outside air introduction passage 8 at a position away from the openings 6 in the cowl top cover 4. For example, when the openings 6 are provided on the right side in the vehicle width direction, the outside air introduction port 19 communicates with the outside air introduction passage 8 on the left side in the vehicle width direction (see FIG. 1).

An inside/outside air switching door 25 is provided inside the first air-conditioning duct 18. The inside/outside air switching door 25 is swingably attached to the first air-conditioning duct 18 at a branching point between the outside air introduction port 19 and the inside air introduction port 20. That is, the inside/outside air switching door 25 is swingable between a position where the opening degree of the inside air introduction port 20 is “0%” and the opening degree of the outside air introduction port 19 is “100%” and a position where the opening degree of the inside air introduction port 20 is “100%” and the opening degree of the outside air introduction port 19 is “0%”.

The inside/outside air switching door 25 is driven by an inside/outside air switching actuator 26 (hereinafter referred to as an actuator 26).

The swinging of the inside/outside air switching door 25 using the actuator 26 allows the inside/outside air switching door 25 to adjust an outside air intake amount E from the outside air introduction port 19 and an inside air intake amount G from the inside air introduction port 20.

A blower fan 27 is disposed downstream of the inside/outside air switching door 25 to blow the air introduced into the first air-conditioning duct 18 into the vehicle interior. The blower fan 27 is coupled to an electrical component such as a blower motor 28.

An evaporator 29 is disposed downstream of the blower fan 27. The evaporator 29 forms a refrigeration cycle together with a compressor 30, a condenser (not illustrated), a receiver tank (not illustrated), an expansion valve (not illustrated), and the like.

The refrigeration cycle allows the evaporator 29 to cool and dehumidify the introduced air blown from the blower fan 27.

The compressor 30 is coupled to an engine output shaft (not illustrated) through an air conditioner clutch 31 such as an electromagnetic clutch. Thus, the air conditioner clutch 31 can switch the drive of the compressor 30 (switch between on and off states) by coupling or decoupling the compressor 30 to or from the engine output shaft.

The heater unit 17 includes a second air-conditioning duct 21. The second air-conditioning duct 21 is provided continuously downstream of the first air-conditioning duct 18. A heater core 47 is disposed inside the second air-conditioning duct 21. The heater core 47 heats the introduced air that has passed through the evaporator 29 by using cooling water of an engine after warm-up.

For example, the heater core 47 is disposed obliquely with respect to the blowing direction of air in the second air-conditioning duct 21. Further, the heater core 47 is provided with an air mix door 48 in a swingable manner.

The air mix door 48 is driven by an opening-degree adjustment actuator 49 (hereinafter referred to as an actuator 49). Accordingly, the actuator 49 can adjust the amount of introduced air passing through the heater core 47 by swinging the air mix door 48.

The second air-conditioning duct 21 has a defroster air outlet 35, a ventilation air outlet 36, and a heater air outlet 37 downstream of the heater core 47.

The defroster air outlet 35 communicates with a defroster duct 40. The defroster duct 40 has opening holes in a downstream portion thereof to blow out conditioned air to the interior surface of the windshield 3.

The ventilation air outlet 36 communicates with a ventilation duct 41 disposed in the instrument panel 10.

The heater air outlet 37 communicates with a heater duct 42.

The second air-conditioning duct 21 is further provided with a defroster door 43, a ventilation door 44, and a heater door 45 to open and close the air outlets 35, 36, and 37, respectively.

The doors 43, 44, and 45 are opened and closed by door switching actuators 46a, 46b, and 46c (hereinafter referred to as actuators 46a to 46c ), respectively. The opening and closing of the doors 43, 44, and 45 allows the actuators 46a to 46c to adjust the ratio of conditioned air flows to be blown out from the air outlets 35, 36, and 37 into the vehicle interior, respectively.

The blower motor 28, the air conditioner clutch 31, and the actuators 26, 46a to 46c, and 49 of the air conditioner 15 having the configuration described above are controlled by the air conditioning control unit 50 serving as a controller, as illustrated in FIG. 2.

The air conditioning control unit 50 includes a known microcomputer and peripheral devices thereof. The known microcomputer includes a central processing unit (CPU), a random access memory (RAM), a read-only memory (ROM), a nonvolatile memory, and so on. The ROM serving as a non-transitory tangible recording medium stores in advance a program to be executed by the CPU, fixed data such as a data table, and so on. All or some of the functions of the controller may be implemented by a logic circuit or an analog circuit. Processing of various programs may be implemented by an electronic circuit such as a field programmable gate array (FPGA).

The input side of the air conditioning control unit 50 is coupled to, for example, an operation panel 52, an inside air temperature sensor 53, an outside air temperature sensor 54, a solar radiation sensor 55, a water temperature sensor 56, a vehicle body angle sensor 57, a raindrop sensor 58, a humidity sensor 59, and an evaporator temperature sensor 60.

The operation panel 52 is disposed on the instrument panel 10 in the interior front portion. The operation panel 52 is provided with, for example, an air conditioning system switch, an automatic operation mode switch, an inside/outside air change switch, a temperature setting switch, and a defroster switch.

The air conditioning system switch is used to switch on and off the air conditioning system 14.

The automatic operation mode switch is used to switch on and off an automatic operation mode of the air conditioner 15.

The inside/outside air change switch is operated by an occupant to change between an outside air introduction mode and an inside air circulation mode of the air conditioner 15.

The temperature setting switch is operated by the occupant to set a set temperature Tset in the vehicle interior.

The defroster switch is operated by the occupant to, for example, switch on and off a defroster. The defroster removes window fogging on the windshield 3.

The following description exemplifies air conditioning control when the automatic operation mode is on.

The inside air temperature sensor 53 is provided in, for example, a lower portion of the instrument panel 10 in the vehicle interior. The inside air temperature sensor 53 detects a vehicle interior temperature Tin. In contrast, the outside air temperature sensor 54 is provided in a lower portion inside a front bumper, for example. The outside air temperature sensor 54 detects an outside temperature Tout.

The solar radiation sensor 55 is provided in an upper portion of the instrument panel 10, for example. The solar radiation sensor 55 detects the amount of solar radiation entering the vehicle interior through the windshield 3 or the like.

The water temperature sensor 56 is provided in a cylinder block of the engine, for example. The water temperature sensor 56 detects the temperature of the cooling water flowing through a water jacket formed in the cylinder block.

The vehicle body angle sensor 57 is constituted by, for example, a gyro sensor. The vehicle body angle sensor 57 serves as a vehicle body angle detector to detect, for example, a pitch angle and a roll angle of the vehicle body 2. As described above, in the present embodiment, the vehicle body angle sensor 57 corresponds to a specific example of a vehicle body angle detector.

The raindrop sensor 58 is installed near the windshield 3, for example. The raindrop sensor 58 detects a rainfall event and further detects the amount of rain falling during a rainfall event. As described above, in the present embodiment, the raindrop sensor 58 corresponds to a specific example of a rainfall amount detector.

The humidity sensor 59 is provided integrally with, for example, the inside air temperature sensor 53 in the lower portion of the instrument panel 10. The humidity sensor 59 detects the relative humidity in the vehicle interior. The humidity sensor 59 also serves as a window fogging detector. As described above, in the present embodiment, the humidity sensor 59 corresponds to a specific example of a relative humidity detector.

The evaporator temperature sensor 60 is provided on an outer surface of a refrigerant pipe of the evaporator 29, for example. The evaporator temperature sensor 60 detects an evaporator temperature.

Based on input signals from the switches and the sensors, the air conditioning control unit 50 performs various kinds of control on the blower motor 28, the air conditioner clutch 31, the actuators 26, 46a to 46c, and 49, and the like with reference to a preset map or the like.

The following mainly describes control performed on the inside/outside air switching door 25 using the actuator 26. In the control of the inside/outside air switching door 25, the air conditioning control unit 50 calculates the inside air intake amount G.

In the calculation of the inside air intake amount G, the air conditioning control unit 50 calculates, for example, a first inside air intake amount G1, a second inside air intake amount G2, and a third inside air intake amount G3.

The first inside air intake amount G1 is calculated based on, for example, input signals from the operation panel 52, the inside air temperature sensor 53, the outside air temperature sensor 54, the solar radiation sensor 55, and the water temperature sensor 56. The first inside air intake amount G1 is calculated as an optimum inside air intake amount to enhance air conditioning efficiency, based on the air conditioning load, in a cooling/heating operation of the air conditioner 15.

In the calculation of the first inside air intake amount G1, for example, the air conditioning control unit 50 calculates a target blowing temperature with respect to the set temperature Tset, based on the vehicle interior temperature Tin, the outside temperature Tout, and the amount of solar radiation. Then, the air conditioning control unit 50 calculates the first inside air intake amount G1 as the inside air intake amount for efficiently adjusting the blowing temperature to the target blowing temperature.

For example, in the cooling operation, when the outside temperature Tout and the vehicle interior temperature Tin are higher than the target blowing temperature and the outside temperature Tout is higher than the vehicle interior temperature Tin (Tout>Tin), the outside air load becomes higher than the inside air load. In this case, by setting the inside air intake amount to be relatively larger than the outside air intake amount, it can be expected that the air conditioning load is reduced and the air conditioning efficiency is enhanced. In the cooling operation, conversely, when the outside temperature Tout and the vehicle interior temperature Tin are higher than the target blowing temperature and the outside temperature Tout is lower than the vehicle interior temperature Tin (Tout<Tin), the inside air load becomes higher than the outside air load. In this case, by setting the inside air intake amount to be relatively smaller than the outside air intake amount, it can be expected that the air conditioning load is reduced and the air conditioning efficiency is enhanced. In addition, various conditions are assumed in order to reduce the air conditioning load and enhance the air conditioning efficiency. The air conditioning control unit 50 stores maps or the like that are set in advance based on various conditions. By referring to such maps or the like, the air conditioning control unit 50 sets the first inside air intake amount G1 as the inside air intake amount for reducing the air conditioning load and enhancing the air conditioning efficiency.

As described above, in the present embodiment, the air conditioning control unit 50 corresponds to a specific example of a first inside air intake amount calculator.

The second inside air intake amount G2 is calculated based on, for example, a control signal for the blower motor 28 and input signals from the vehicle body angle sensor 57 and the raindrop sensor 58. That is, as the second inside air intake amount G2, a minimum inside air intake amount for limiting the ingress of moisture from the outside air introduction port 19 is calculated based on the amount of air blown by the blower fan 27, the vehicle body angle of the vehicle body 2, and a weather condition. For example, when it is estimated that the likelihood of moisture ingress from the outside air introduction port 19 is high based on the amount of rainfall and the vehicle body angle, it is desirable to limit the outside air intake amount in order to limit the ingress of moisture. For example, in a case where the amount of air blown by the blower fan 27 is constant, the outside air intake amount and the inside air intake amount have a trade-off relationship. In this case, accordingly, the air conditioning control unit 50 sets the second inside air intake amount G2 to be higher than that when the likelihood of moisture ingress is low.

In one example, the second inside air intake amount G2 is calculated based on, for example, a reference inside air intake amount S, a correction amount A based on a vehicle body longitudinal angle, a correction amount B based on a vehicle body lateral angle, and a correction amount C based on an amount of rainfall.

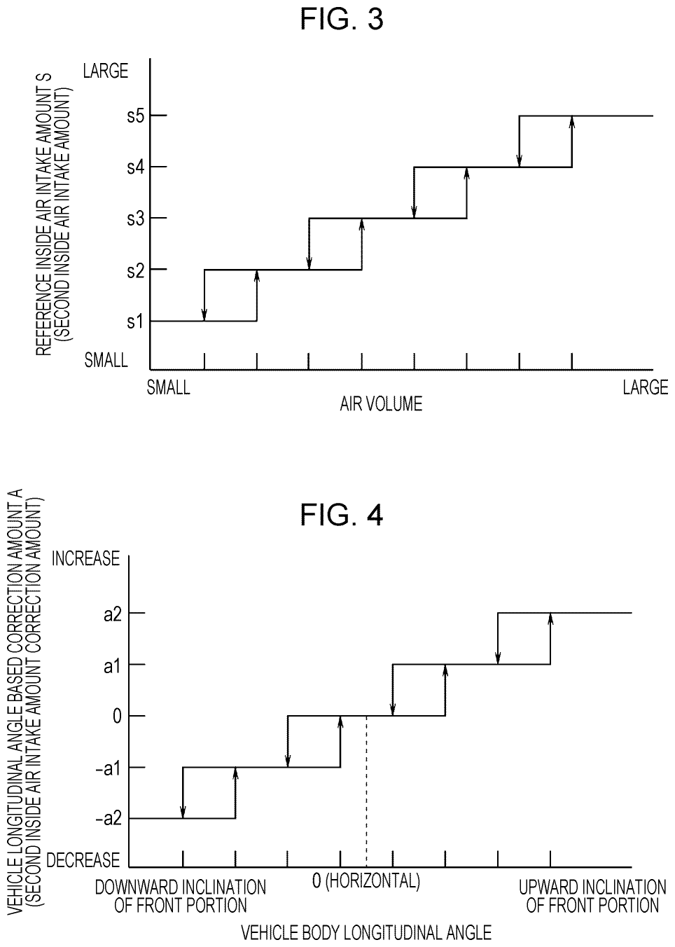

The reference inside air intake amount S is calculated with reference to, for example, a reference inside air intake amount calculation map illustrated in FIG. 3, based on the air volume of the blower fan 27. The reference inside air intake amount calculation map is a map for controlling the outside air intake amount to be smaller than or equal to a predetermined mixing amount. In the example illustrated in FIG. 3, the reference inside air intake amount S calculated using the reference inside air intake amount calculation map increases stepwise over a range of s1 to s5 as the air volume of the blower fan 27 increases.

The correction amount A based on the vehicle body longitudinal angle is calculated with reference to, for example, a correction amount calculation map illustrated in FIG. 4, based on the vehicle body longitudinal angle. The correction amount A based on the vehicle body longitudinal angle is a correction amount for correcting the reference inside air intake amount S to the “increase” side as the inclination of the outside air introduction port 19 in a direction likely to allow moisture ingress increases due to the inclination of the vehicle body 2 in the front-back direction. The outside air introduction port 19 according to the present embodiment is opened toward the front of the vehicle body 2. Accordingly, as illustrated in FIG. 4, the correction amount A calculated using the correction amount calculation map increases stepwise over a range of 0 to a2 as the upward inclination of the front portion of the vehicle body 2 increases, for example.

As illustrated in FIG. 4, in contrast, the correction amount A calculated using the correction amount calculation map is a correction amount for correcting the reference inside air intake amount S to the “decrease” side as the downward inclination of the front portion of the vehicle body 2 increases. Accordingly, the correction amount A calculated using the correction amount calculation map decreases stepwise over a range of 0 to −a2 as the downward inclination of the front portion of the vehicle body 2 increases, for example.

The correction amount B based on the vehicle body lateral angle is calculated with reference to, for example, a correction amount calculation map illustrated in FIG. 5, based on the vehicle body lateral angle. The correction amount B based on the vehicle body lateral angle is a correction amount for correcting the reference inside air intake amount S to the “increase” side as the inclination of the outside air introduction port 19 in a direction likely to allow moisture ingress increases due to the inclination of the vehicle body 2 in the left-right direction. The outside air introduction port 19 according to the present embodiment is provided in the left portion (near the passenger seat) of the vehicle body 2. Accordingly, as illustrated in FIG. 5, the correction amount B calculated using the correction amount calculation map increases stepwise over a range of 0 to b2 as the downward inclination of the left portion of the vehicle body 2 increases, for example.

As illustrated in FIG. 5, in contrast, the correction amount B calculated using the correction amount calculation map is a correction amount for correcting the reference inside air intake amount S to the “decrease” side as the upward inclination of the left portion of the vehicle body 2 increases. Accordingly, the correction amount B calculated using the correction amount calculation map decreases stepwise over a range of 0 to −b2 as the upward inclination of the left portion of the vehicle body 2 increases, for example.

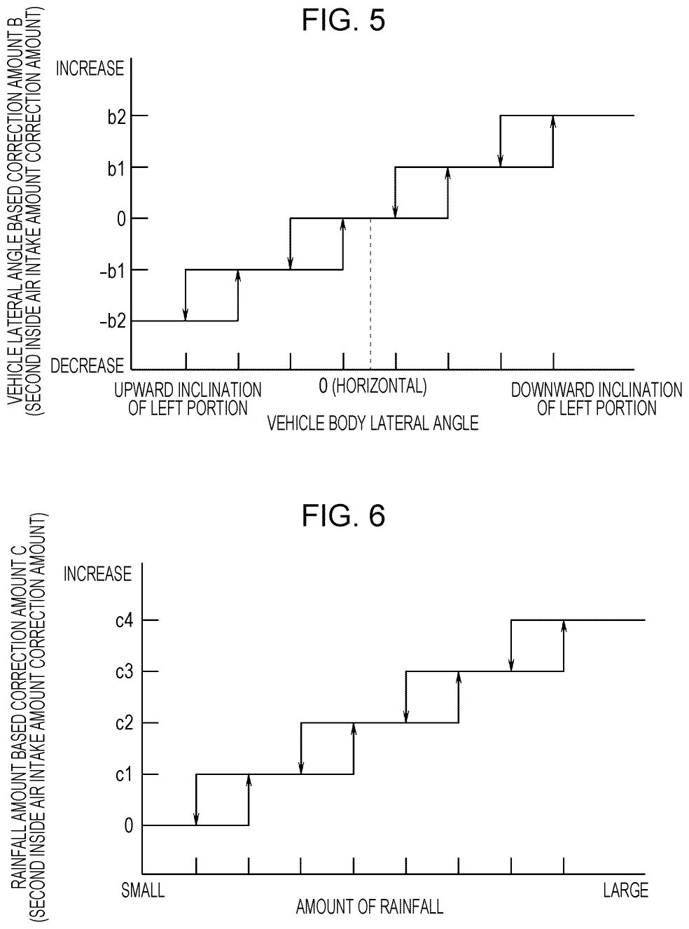

The correction amount C based on the amount of rainfall is calculated with reference to, for example, a correction amount calculation map illustrated in FIG. 6, based on the amount of rainfall. The correction amount C based on the amount of rainfall is a correction amount for correcting the reference inside air intake amount S to the “increase” side as the amount of rainfall increases. Accordingly, as illustrated in FIG. 6, the correction amount C calculated using the correction amount calculation map increases stepwise over a range of 0 to c4 as the amount of rainfall increases, for example.

Based on the calculation maps described above, the air conditioning control unit 50 calculates the second inside air intake amount G2 using equation (1) below.

$$G 2 = S + A + B + C \qquad ( 1 )$$

The second inside air intake amount G2 can be corrected using a previously calculated mean value of the second inside air intake amount G2. For example, the air conditioning control unit 50 calculates a mean value for each interval of preset cycles based on second inside air intake amounts G2 continuously calculated at set time intervals. Then, the air conditioning control unit 50 compares the previous mean value with the latest mean value, and sets the latest mean value as the final second inside air intake amount G2 when the previous mean value is smaller.

On the other hand, when the previous mean value is continuously larger than the latest mean value for a period of set time, the air conditioning control unit 50 replaces the second inside air intake amount G2 with the latest mean value. When the previous mean value of the second inside air intake amount G2 is not continuously larger than the latest mean value for the period of set time, the air conditioning control unit 50 maintains the previous mean value of the second inside air intake amount G2.

Thus, when the previous mean value of the second inside air intake amount G2 is smaller than the latest mean value, the air conditioning control unit 50 immediately uses the latest mean value as the final second inside air intake amount G2. On the other hand, when the previous mean value is larger than the latest mean value, the air conditioning control unit 50 replaces the final second inside air intake amount G2 with the latest mean value after the previous mean value is continuously larger than the latest mean value for a period of set time.

The calculation maps illustrated in FIGS. 3, 4, 5, and 6 are obtained in advance by an experiment or the like for each vehicle type or each specification of the air conditioning system 14, for example. Further, in each of the calculation maps, the value to be determined slightly differs between the increase time and the decrease time because hysteresis is applied to prevent hunting operations.

As described above, in the present embodiment, the air conditioning control unit 50 corresponds to a specific example of a second inside air intake amount calculator.

The third inside air intake amount G3 is calculated based on, for example, an input signal from the humidity sensor 59. As the third inside air intake amount G3, the maximum allowed value of the inside air intake amount to limit window fogging is calculated based on relative humidity information.

For example, based on relative humidity information in the vehicle interior, the air conditioning control unit 50 estimates the dew-point temperature in the vicinity of the windshield 3 from a preset map or the like. Then, the air conditioning control unit 50 estimates the state of window fogging on the windshield 3 from the temperature in the vehicle interior. For example, when it is estimated that window fogging is likely to occur, the inside air intake amount is reduced to increase the outside air intake amount in order to limit window fogging. In this case, accordingly, the air conditioning control unit 50 sets the third inside air intake amount G3 to be low in order to increase the outside air intake amount to enhance the effect of limiting window fogging.

As described above, in the present embodiment, the air conditioning control unit 50 corresponds to a specific example of a third inside air intake amount calculator.

In principle, the air conditioning control unit 50 sets the larger of the first inside air intake amount G1 and the second inside air intake amount G2 as the final inside air intake amount G. Note that the value of the final inside air intake amount G is restricted to a value smaller than or equal to the third inside air intake amount G3 in order to limit window fogging. In addition, when the defroster air outlet 35 is included as a conditioned air outlet, the air conditioning control unit 50 sets the final inside air intake amount G to “0”. Further, immediately after the ignition switch is switched from on to off, the air conditioning control unit 50 sets the final inside air intake amount G to “0” or a value corresponding to the total air volume of the first air-conditioning duct 18.

Then, based on the final inside air intake amount G, the air conditioning control unit 50 controls the drive of the actuator 26 and controls the opening degree of the inside/outside air switching door 25.

As described above, in the present embodiment, the air conditioning control unit 50 corresponds to a specific example of an inside air intake amount setter.

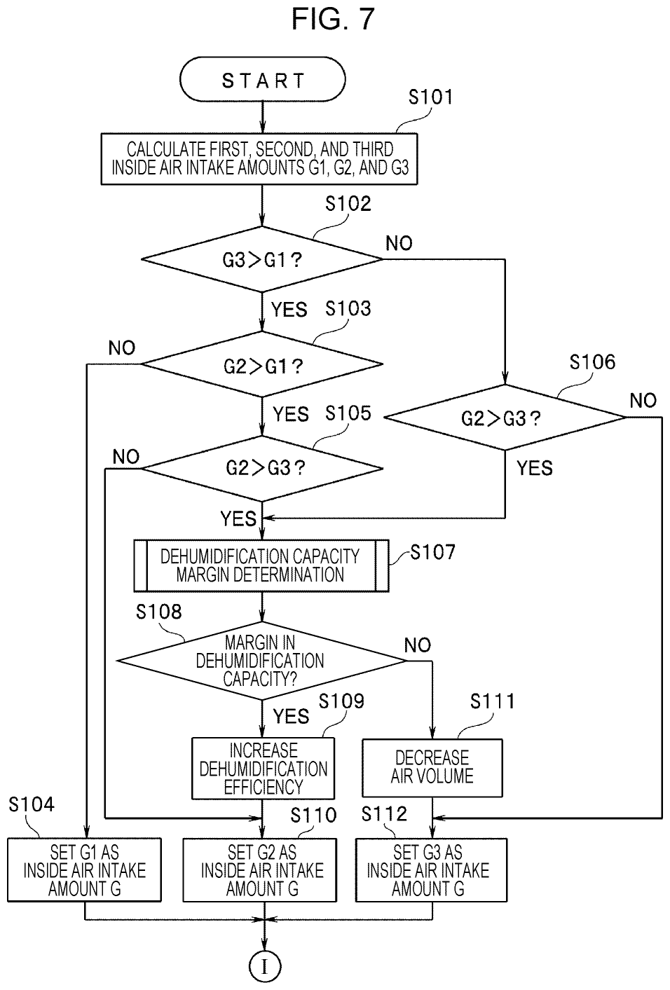

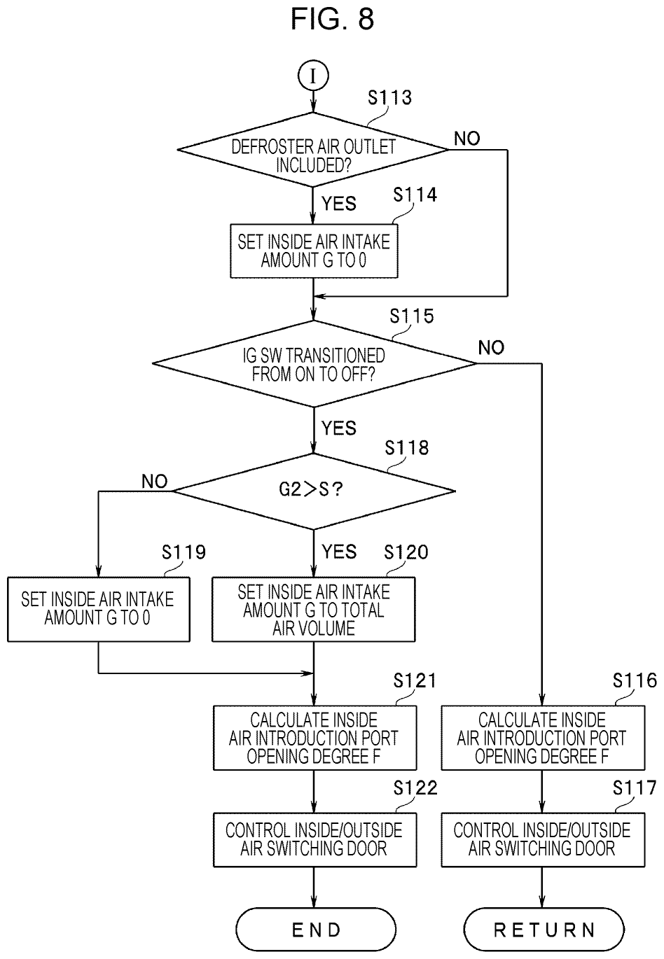

Next, the control of the inside air intake amount by the air conditioning control unit 50 according to the present embodiment will be described with reference to a flowchart of an inside air intake amount control routine illustrated in FIGS. 7 and 8.

The routine is repeatedly executed by the air conditioning control unit 50 at set time intervals.

As illustrated in FIG. 7, first, when the routine starts, in step S101, the air conditioning control unit 50 calculates the first, second, and third inside air intake amounts G1, G2, and G3.

Then, in step S102, the air conditioning control unit 50 determines whether the third inside air intake amount G3 is larger than the first inside air intake amount G1.

If the air conditioning control unit 50 determines in step S102 that the third inside air intake amount G3 is smaller than or equal to the first inside air intake amount G1 (step S102: NO), the process proceeds to step S106 described below.

On the other hand, if the air conditioning control unit 50 determines in step S102 that the third inside air intake amount G3 is larger than the first inside air intake amount G1 (step S102: YES), the process proceeds to step S103.

When the process proceeds from step S102 to step S103, the air conditioning control unit 50 determines whether the second inside air intake amount G2 is larger than the first inside air intake amount G1.

If the air conditioning control unit 50 determines in step S103 that the second inside air intake amount G2 is smaller than or equal to the first inside air intake amount G1 (step S103: NO), the process proceeds to step S104. That is, when the first inside air intake amount G1 is smaller than the third inside air intake amount G3 and is larger than or equal to the second inside air intake amount G2 (G3>G1≥G2), the air conditioning control unit 50 causes the process to proceed to step S104.

Then, in step S104, the air conditioning control unit 50 sets the first inside air intake amount G1 as the final inside air intake amount G. Thereafter, the air conditioning control unit 50 causes the process to proceed to step S113 described below.

On the other hand, if the air conditioning control unit 50 determines in step S103 that the second inside air intake amount G2 is larger than the first inside air intake amount G1 (step S103: YES), the process proceeds to step S105.

When the process proceeds from step S103 to step S105, the air conditioning control unit 50 determines whether the second inside air intake amount G2 is larger than the third inside air intake amount G3.

If the air conditioning control unit 50 determines in step S105 that the second inside air intake amount G2 is smaller than or equal to the third inside air intake amount G3 (step S105: NO), the process proceeds to step S110. That is, when the second inside air intake amount G2 is smaller than or equal to the third inside air intake amount G3 and is larger than the first inside air intake amount G1 (G3≥G2>G1), the air conditioning control unit 50 causes the process to proceed to step S110 described below.

On the other hand, if the air conditioning control unit 50 determines in step S105 that the second inside air intake amount G2 is larger than the third inside air intake amount G3 (step S105: YES), the process proceeds to step S107. That is, when the third inside air intake amount G3 is smaller than the second inside air intake amount G2 and is larger than the first inside air intake amount G1 (G2>G3>G1), the air conditioning control unit 50 proceeds to step S107 described below.

When the process proceeds from step S102 to step S106, the air conditioning control unit 50 determines whether the second inside air intake amount G2 is larger than the third inside air intake amount G3.

If the air conditioning control unit 50 determines in step S106 that the second inside air intake amount G2 is smaller than or equal to the third inside air intake amount G3 (step S106: NO), the process proceeds to step S112. That is, when the third inside air intake amount G3 is smaller than or equal to the first inside air intake amount G1 and is larger than or equal to the second inside air intake amount G2 (G1>G3>G2), the air conditioning control unit 50 causes the process to proceed to step S112 described below.

On the other hand, if the air conditioning control unit 50 determines in step S106 that the second inside air intake amount G2 is larger than the third inside air intake amount G3 (step S106: YES), the process proceeds to step S107.

That is, when the third inside air intake amount G3 is smaller than the second inside air intake amount G2 and is smaller than or equal to the first inside air intake amount G1 (G2>G3≤G1), the air conditioning control unit 50 causes the process to proceed to step S107.

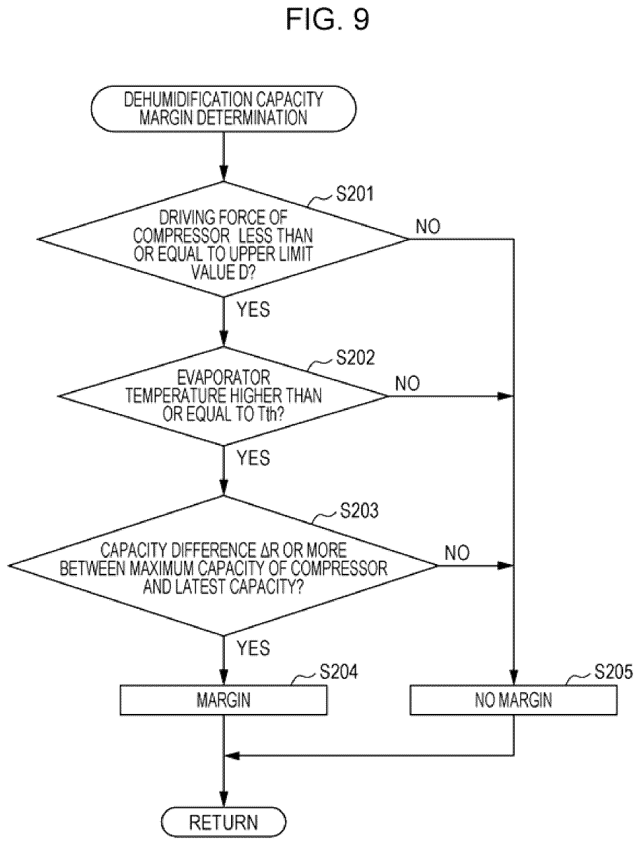

When the process proceeds from step S105 or S106 to step S107, the air conditioning control unit 50 determines whether the dehumidification capacity of the air conditioner 15 has a margin. That is, the air conditioning control unit 50 performs a dehumidification capacity margin determination when the second inside air intake amount G2 is larger than the third inside air intake amount G3. The dehumidification capacity margin determination is performed based on, for example, a dehumidification capacity margin determination subroutine illustrated in FIG. 9.

When the subroutine starts, for example, in step S201, the air conditioning control unit 50 determines whether the driving force of the compressor 30 is less than or equal to a predetermined upper limit driving force value D set in advance.

If the air conditioning control unit 50 determines in step S201 that the driving force is greater than the upper limit driving force value D (step S201: NO), the process proceeds to step S205.

On the other hand, if the air conditioning control unit 50 determines in step S201 that the driving force is less than or equal to the upper limit driving force value D (step S201: YES), the process proceeds to step S202.

In step S202, for example, the air conditioning control unit 50 determines whether the temperature of the evaporator 29 (evaporator temperature) is higher than or equal to a preset threshold temperature Tth. The threshold temperature Tth is a value obtained by adding a predetermined margin (e.g., 5° C.) to a lower limit value (e.g., 0° C.) of the temperature of the evaporator 29 obtained based on the capacity or the like of the compressor 30.

If the air conditioning control unit 50 determines in step S202 that the evaporator temperature is lower than the threshold temperature Tth (step S202: NO), the process proceeds to step S205.

On the other hand, if the air conditioning control unit 50 determines in step S202 that the evaporator temperature is higher than or equal to the threshold temperature Tth (step S202: YES), the process proceeds to step S203.

In step S203, for example, the air conditioning control unit 50 determines whether the difference between the maximum capacity of the compressor 30 and the latest capacity is greater than or equal to a capacity difference ΔR.

If the air conditioning control unit 50 determines in step S203 that the difference between the maximum capacity and the latest capacity is less than the capacity difference ΔR (step S203: NO), the process proceeds to step S205.

On the other hand, if the air conditioning control unit 50 determines in step S203 that the difference between the maximum capacity and the latest capacity is greater than or equal to the capacity difference ΔR (step S203: YES), the air conditioning control unit 50 causes the process to proceed to step S204 and determines that the dehumidification capacity has a margin.

After determining in step S204 that the dehumidification capacity has a margin, the air conditioning control unit 50 exits the subroutine.

When the process proceeds from step S201, S202, or S203 to step S205, the air conditioning control unit 50 determines that the dehumidification capacity has no margin, and then exits the subroutine.

In the main routine illustrated in FIG. 7, when the process proceeds from step S107 to step S108, the air conditioning control unit 50 determines whether the dehumidification capacity has a margin.

If the air conditioning control unit 50 determines in step S108 that the dehumidification capacity has no margin (step S108: NO), the process proceeds to step S111.

On the other hand, if the air conditioning control unit 50 determines in step S108 that the dehumidification capacity has a margin (step S108: YES), the process proceeds to step S109.

When the process proceeds from step S108 to step S109, the air conditioning control unit 50 increases the dehumidification efficiency of the air conditioner 15, and then causes the process to proceed to step S110. For example, the air conditioning control unit 50 controls the compressor 30 and the like to increase the cooling capacity of the evaporator 29. Accordingly, the dehumidification efficiency of the air conditioner 15 is increased. This allows the air conditioning control unit 50 to limit window fogging on the windshield 3 even when the inside air intake amount is maintained high.

When the process proceeds from step S105 or S109 to step S110, the air conditioning control unit 50 sets the second inside air intake amount G2 as the final inside air intake amount G. Thereafter, the air conditioning control unit 50 causes the process to proceed to step S113 described below.

When the process proceeds from step S108 to step S111, the air conditioning control unit 50 controls the drive of the blower fan 27 to decrease the air volume in the first air-conditioning duct 18 to a predetermined air volume, and then causes the process to proceed to step S112. Accordingly, the air conditioning control unit 50 can limit the ingress of rainwater even when the inside air intake amount is set to be lower than that set to prioritize the limiting of window fogging. Further, by decreasing the air volume in the first air-conditioning duct 18 to the predetermined air volume, the air conditioning control unit 50 can decrease the inside air intake amount without increasing the outside air intake amount.

When the process proceeds from step S106 or S111 to step S112, the air conditioning control unit 50 sets the third inside air intake amount G3 as the final inside air intake amount G. Thereafter, the air conditioning control unit 50 causes the process to proceed to step S113.

When the process proceeds from step S104, S110, or S112 to step S113 (see FIG. 8), the air conditioning control unit 50 determines whether the defroster air outlet 35 is included as a conditioned air outlet.

If the air conditioning control unit 50 determines in step S113 that the defroster air outlet 35 is not included as a conditioned air outlet (step S113: NO), the process proceeds to step S115 with the set inside air intake amount G maintained.

On the other hand, if the air conditioning control unit 50 determines in step S113 that the defroster air outlet 35 is included as a conditioned air outlet (step S113: YES), the process proceeds to step S114.

When the process proceeds from step S113 to step S114, the air conditioning control unit 50 sets the inside air intake amount G to “0”. That is, if the air conditioning control unit 50 determines that the defroster air outlet 35 is included as a conditioned air outlet, the air conditioning control unit 50 replaces the final inside air intake amount G with “0”. Thereafter, the air conditioning control unit 50 causes the process to proceed to step S115. When the process proceeds from step S113 or S114 to step S115, the air conditioning control unit 50 determines whether the ignition switch has just transitioned from on to off.

If the air conditioning control unit 50 determines in step S115 that the ignition switch has not transitioned from on to off (step S115: NO), the process proceeds to step S116.

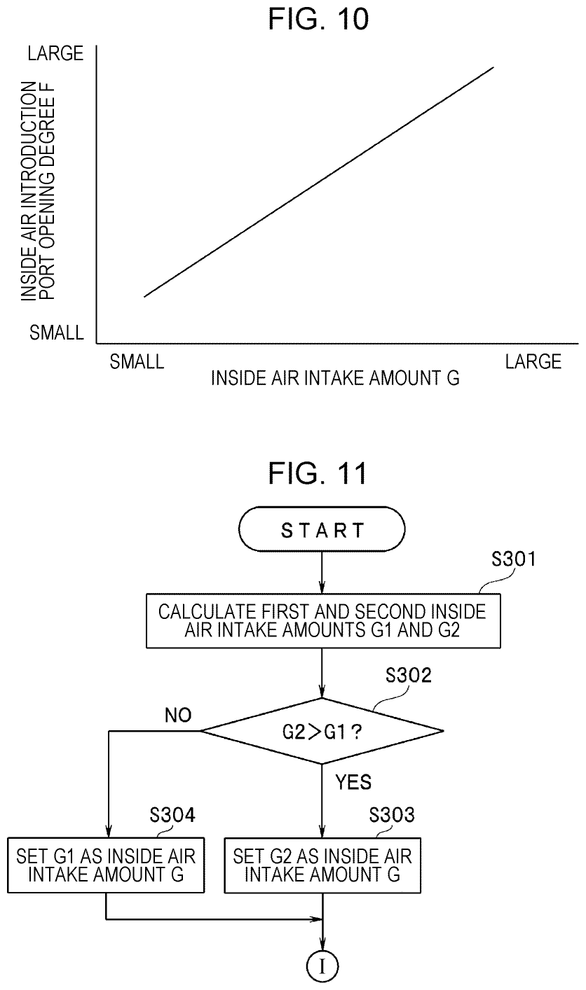

In step S116, the air conditioning control unit 50 calculates an inside air introduction port opening degree F. (hereinafter referred to as an opening degree F.), based on the final inside air intake amount G. The opening degree F. is calculated using, for example, a preset calculation map (see FIG. 10). The calculation map is obtained in advance by an experiment or the like for each vehicle type or each specification of the air conditioning system 14, for example. In the present embodiment, as an example, the opening degree F. is calculated using the calculation map. However, the opening degree F. may be calculated using a mathematical expression.

Then, in step S117, the air conditioning control unit 50 controls the opening degree of the inside/outside air switching door 25 based on the opening degree F., and then exits the routine.

The opening degree F. is an example of an index for controlling the drive of the inside/outside air switching door 25. An index other than the opening degree may be used.

On the other hand, if the air conditioning control unit 50 determines in step S115 that the ignition switch has just transitioned from on to off (step S115: YES), the process proceeds to step S118.

When the process proceeds from step S115 to step S118, the air conditioning control unit 50 determines whether the second inside air intake amount G2 is larger than the reference inside air intake amount S.

If the air conditioning control unit 50 determines in step S118 that the second inside air intake amount G2 is smaller than or equal to the reference inside air intake amount S (step S118: NO), the process proceeds to step S119.

When the process proceeds from step S118 to step S119, the air conditioning control unit 50 sets the inside air intake amount G to “0”. That is, when it is determined that the ignition switch has just transitioned from on to off and when it is determined that the second inside air intake amount G2 is smaller than or equal to the reference inside air intake amount S, the air conditioning control unit 50 replaces the final inside air intake amount G with “0”. Thereafter, the air conditioning control unit 50 causes the process to proceed to step S121.

On the other hand, if the air conditioning control unit 50 determines in step S118 that the second inside air intake amount G2 is larger than the reference inside air intake amount S (step S118: YES), the process proceeds to step S120.

When the process proceeds from step S118 to step S120, the air conditioning control unit 50 sets the inside air intake amount G to a value corresponding to the total air volume in the first air-conditioning duct 18, that is, 100% inside air. That is, when it is determined that the ignition switch has just transitioned from on to off and when it is determined that the second inside air intake amount G2 is larger than the reference inside air intake amount S, the air conditioning control unit 50 replaces the final inside air intake amount G with the total air volume in the first air-conditioning duct 18. Thereafter, the air conditioning control unit 50 causes the process to proceed to step S121.

When the process proceeds from step S119 or S120 to step S121, the air conditioning control unit 50 calculates the opening degree F. based on the final inside air intake amount G in a manner similar to that described above.

Then, in step S122, the air conditioning control unit 50 controls the opening degree of the inside/outside air switching door 25 based on the opening degree F., and then ends the routine.

According to the embodiment described above, the air conditioning system 14 includes the inside/outside air switching door 25 configured to adjust the outside air intake amount E from the outside air introduction port 19 and the inside air intake amount G from the inside air introduction port 20, and the air conditioning control unit 50 configured to control the inside/outside air switching door 25. The air conditioning control unit 50 is configured to calculate the first inside air intake amount G1 for achieving high air conditioning efficiency, based on the air conditioning load, calculate the second inside air intake amount G2 for limiting ingress of moisture from the outside air introduction port 19, based on a vehicle body angle and a weather condition, and set the inside air intake amount G using the inside/outside air switching door 25, based on a larger one of the first inside air intake amount G1 and the second inside air intake amount G2.

This allows the air conditioning system 14 to limit the ingress of rainwater into the outside air introduction port 19 even when a weather condition changes and the inclination of the vehicle body 2 changes, while achieving high air conditioning efficiency.

That is, in the air conditioning system 14, the air conditioning control unit 50 calculates the first inside air intake amount G1 and the second inside air intake amount G2, and sets the inside air intake amount G using the inside/outside air switching door 25, based on the larger one of the first inside air intake amount G1 and the second inside air intake amount G2. This allows the air conditioning system 14 to always set the inside air intake amount G satisfying the requirement of the second inside air intake amount G2. Thus, the air conditioning system 14 can limit the ingress of moisture from the outside air introduction port 19. When the first inside air intake amount G1 is larger than the second inside air intake amount G2, the air conditioning control unit 50 sets the inside air intake amount G using the inside/outside air switching door 25, based on the first inside air intake amount G1. Thus, the air conditioning system 14 can enhance air conditioning efficiency while limiting the ingress of moisture from the outside air introduction port 19.

In the present embodiment, additionally, the air conditioning control unit 50 calculates the third inside air intake amount G3 for limiting window fogging on the windshield 3. In principle, the air conditioning control unit 50 sets the inside air intake amount G so as not to exceed the third inside air intake amount G3. Thus, it is possible to limit window fogging on the windshield 3.

In this case, when the second inside air intake amount G2 is larger than the third inside air intake amount G3 and the dehumidification capacity has a margin, the air conditioning control unit 50 exceptionally sets the inside air intake amount G based on the second inside air intake amount G2 in a state of enhanced dehumidification capacity. Thus, the air conditioning system 14 can limit both window fogging on the windshield 3 and the ingress of moisture from the outside air introduction port 19.

On the other hand, when the second inside air intake amount G2 is larger than the third inside air intake amount G3 and the dehumidification capacity has no margin, the air conditioning control unit 50 sets the inside air intake amount G based on the third inside air intake amount G3 in a state where the air volume of the blower fan 27 has been decreased. This allows the air conditioning control unit 50 to substantially limit an increase in the outside air intake amount also when the inside air intake amount G smaller than the second inside air intake amount G2 is set based on the third inside air intake amount G3. Thus, the air conditioning system 14 can limit both window fogging on the windshield 3 and the ingress of moisture from the outside air introduction port 19 even when the dehumidification capacity has no margin.

When calculating the second inside air intake amount G2, the air conditioning control unit 50 corrects the second inside air intake amount G2 using a previously calculated mean value of the second inside air intake amount G2. For example, when the previous mean value of the second inside air intake amount G2 is smaller than the latest mean value for each interval of cycles, the air conditioning control unit 50 immediately uses the latest mean value as the final second inside air intake amount G2. On the other hand, when the previous mean value is larger than the latest mean value, the air conditioning control unit 50 replaces the final second inside air intake amount G2 with the latest mean value after the previous mean value is continuously larger than the latest mean value for a period of set time. Through such calculation of the second inside air intake amount G2, the air conditioning control unit 50 can limit hunting during the switching operation of the inside/outside air switching door 25. Thus, the air conditioning system 14 can limit an unnecessary switching operation of the inside/outside air switching door 25 and thus improve the durability of the actuator 26.

After the final inside air intake amount G is set, when it is determined that the defroster air outlet 35 is included as a conditioned air outlet, the air conditioning control unit 50 replaces the final inside air intake amount G with “0”. This allows the air conditioning system 14 to prioritize the addressing of window fogging and thus ensure that the occupant has clear visibility.

After the final inside air intake amount G is set, furthermore, when it is determined that the ignition switch has just transitioned from on to off and when it is determined that the second inside air intake amount G2 is larger than the reference inside air intake amount S, the air conditioning control unit 50 sets the final inside air intake amount G to a value corresponding to the total air volume in the first air-conditioning duct 18, that is, 100% inside air. This allows the air conditioning system 14 to accurately limit the ingress of moisture from the outside air introduction port 19 even when the vehicle 1 is parked or stopped in a condition where the likelihood of the ingress of rainwater from the outside air introduction port 19 is high. On the other hand, when it is determined that the ignition switch has just transitioned from on to off and when it is determined that the second inside air intake amount G2 is smaller than or equal to the reference inside air intake amount S, the air conditioning control unit 50 sets the final inside air intake amount G to “0”. This allows the air conditioning system 14 to implement a high in-vehicle ventilation function when the ignition switch is turned on again.

Such air conditioning control can be applied to various types of vehicles having different shapes of the cowl top cover 4. Thus, the air conditioning system 14 can limit the ingress of moisture from the outside air introduction port 19 without changing the shape of the cowl top cover 4.

Next, a modification of the control of the inside air intake amount by the air conditioning control unit 50 according to the present embodiment will be described. In this modification, the processing of steps S301 to S304 illustrated in FIG. 11 is performed in place of the processing of steps S101 to S112 described above. A process according to this modification can be applied to, for example, the control of the air conditioning system 14 that does not include the humidity sensor 59.

As illustrated in FIG. 11, when the routine starts, first, in step S301, the air conditioning control unit 50 calculates the first and second inside air intake amounts G1 and G2.

Then, in step S302, the air conditioning control unit 50 determines whether the second inside air intake amount G2 is larger than the first inside air intake amount G1. If the air conditioning control unit 50 determines in step S302 that the second inside air intake amount G2 is larger than the first inside air intake amount G1 (step S302: YES), the process proceeds to step S303.

When the process proceeds from step S302 to step S303, the air conditioning control unit 50 sets the second inside air intake amount G2 as the final inside air intake amount G. Thereafter, the air conditioning control unit 50 causes the process to proceed to step S113 (see FIG. 8).

On the other hand, if the air conditioning control unit 50 determines in step S302 that the second inside air intake amount G2 is smaller than or equal to the first inside air intake amount G1 (step S302: NO), the process proceeds to step S304.

When the process proceeds from step S302 to step S304, the air conditioning control unit 50 sets the first inside air intake amount G1 as the final inside air intake amount G. Thereafter, the air conditioning control unit 50 causes the process to proceed to step S113 (see FIG. 8).

The processing of step S113 and the subsequent processing are similar to those in the embodiment described above, and a description thereof will thus be omitted.

According to the embodiment described above, also for a type of vehicle that does not include the humidity sensor 59, the air conditioning system 14 can limit the ingress of rainwater into the outside air introduction port 19 even when the inclination of the vehicle body 2 changes, while achieving high air conditioning efficiency.

In the present embodiment, as an example, the air conditioning system 14 is installed in a right-hand drive vehicle in which the driver's seat is on the right side. However, the air conditioning system 14 may also be applied to a left-hand drive vehicle in which the driver's seat is on the left side.

While an embodiment of the disclosure has been described, such an embodiment is for illustrative purposes only, and various modifications may be made in implementations of the disclosure without departing from the scope of the disclosure. The embodiment includes various aspects of the disclosure, and various aspects of the disclosure may be extracted by any appropriate combination of constituent elements disclosed herein.

In some aspects, some of the constituent elements illustrated in the embodiment described above may be omitted as long as the issues described herein can be addressed and the effects described herein can be achieved.

The air conditioning control unit 50 illustrated in FIG. 2 can be implemented by circuitry including at least one semiconductor integrated circuit such as at least one processor (e.g., a central processing unit (CPU)), at least one application specific integrated circuit (ASIC), and/or at least one field programmable gate array (FPGA). At least one processor can be configured, by reading instructions from at least one machine readable tangible medium, to perform all or a part of functions of the air conditioning control unit 50. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the non-volatile memory may include a ROM and a NVRAM. The ASIC is an integrated circuit (IC) customized to perform, and the FPGA is an integrated circuit designed to be configured after manufacturing in order to perform, all or a part of the functions of the modules illustrated in FIG. 2.

1. A vehicle air conditioning system comprising:
an inside/outside air switching door configured to adjust an outside air intake amount from an outside air introduction port and an inside air intake amount from an inside air introduction port;
a first inside air intake amount calculator configured to calculate a first inside air intake amount for achieving high air conditioning efficiency, based on an air conditioning load;
a second inside air intake amount calculator configured to calculate a second inside air intake amount for limiting ingress of moisture from the outside air introduction port, based on a vehicle body angle and a weather condition; and
an inside air intake amount setter configured to set the inside air intake amount using the inside/outside air switching door, based on a larger one of the first inside air intake amount and the second inside air intake amount.

2. The vehicle air conditioning system according to claim 1, further comprising a third inside air intake amount calculator configured to calculate a third inside air intake amount for limiting window fogging, based on information on humidity in a vehicle interior, wherein the inside air intake amount setter is configured to set the inside air intake amount based on the third inside air intake amount when the third inside air intake amount is larger than or equal to the second inside air intake amount in a case where the first inside air intake amount is larger than the second inside air intake amount.

3. The vehicle air conditioning system according to claim 2, wherein the inside air intake amount setter is configured to set the inside air intake amount based on the second inside air intake amount in a state of enhanced dehumidification efficiency when the second inside air intake amount is larger than the third inside air intake amount and dehumidification capacity has a margin.

4. The vehicle air conditioning system according to claim 1, wherein the second inside air intake amount calculator is configured to:
continuously calculate a plurality of second inside air intake amounts at set time intervals, each of the second inside air intake amounts comprising the second inside air intake amount;
calculate a previous mean value and a latest mean value for each interval of preset cycles based on the calculated second inside air intake amounts; and
replace the second inside air intake amount with the latest mean value when the previous mean value is continuously larger than the latest mean value for a period of set time.

5. A vehicle air conditioning system comprising:
an inside/outside air switching door configured to adjust an outside air intake amount from an outside air introduction port and an inside air intake amount from an inside air introduction port; and
a controller comprising circuitry and configured to control the inside/outside air switching door, wherein
the controller is configured to:
calculate a first inside air intake amount for achieving high air conditioning efficiency, based on an air conditioning load;
calculate a second inside air intake amount for limiting ingress of moisture from the outside air introduction port, based on a vehicle body angle and a weather condition; and
set the inside air intake amount using the inside/outside air switching door, based on a larger one of the first inside air intake amount and the second inside air intake amount.
